(19) United States
(12) Patent Application Publication
(10) Pub. No.: US 2023/0247342 A1
(43) Pub. Date: Aug. 3, 2023

(54) A BALANCING DEVICE FOR PREVENTING ACCIDENTAL FALL OUT OF A WIRELESS EARBUD

(71) Applicant: Brian Pemberton, Hong Kong (CN)

(72) Inventor: Brian Pemberton, Hong Kong (CN)

(21) Appl. No.: 18/004,948

(22) PCT Filed: Jul. 10, 2021
(86) PCT No.: PCT/IB2021/056213

§ 371 Date: Jan. 10, 2023

(51) Int. Cl. H04R 1/10

(52) U.S. Cl. CPC H04R 1/105; H04R 1/1016; H04R 2420/07

(57) ABSTRACT

Provided herein is a balancing device for preventing accidental fall out of a wireless earbud OR TWS, when the wireless earbud is dislodged during any activity such as but not limited to exercise or running activities. The balancing device includes a flexible element arranged to wrap around the back of the ear; and a counterweight, wherein the flexible element is configured to hang over the top of a user's ear and the counterweight is attached to the flexible element to counteract the weight of the wireless earbud, thereby the wireless earbud is stopped from slipping off and falling to the ground, when the earbud is accidently dropped or dislodged from the ear. The balancing device is compatible with a regular ear-rings or any other ear jewellery with a metal plate with a hole.

### FIELD OF THE INVENTION

The present disclosure generally relates to a device attached to an ear-fitting headset, and particularly relates to a balancing device attached to a wireless in-ear earbud or true wireless Stereo (TWS) for preventing accidental fall of the earbud from the ear to the ground.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Wireless earbuds have been very popular accessories for mobile devices due to their convenience and easy portability. The light-weight earbuds sit on the outer ears and may be partially inserted into the ear canal for improving the audio quality. Most wireless earbuds use Bluetooth® technology to digitally encode the audio and wirelessly transmit the signal over a short distance to and from the linked mobile device. The convenience of the lack of connecting wires comes with the shortcoming of a risk of accidental fall of the earbuds from the ear to the ground. The earbud is generally not fit securely and may fall out easily especially when the user is playing sports or doing exercises. In some cases, the result can be either damage or loss of the earbuds.

Some earbuds have additional in-ear elements, typically made of silicone or other flexible foam-type materials that conform to the shape of the ear canal wall for holding the earbud more firmly in the ear. They may have additional shaped elements designed to push against the Conch of the ear. However, the pressure on the skin to help to keep a tight fit in the ear canal or conch can be uncomfortable to the user after prolonged use. The earbuds may still physically fall from the wearer if the earbuds are dislodged.

Another approach is to provide a ridged curved clip designed to fit the clip over the top of the ear, thereby the earbud can be held in place by the clip. However, this approach has the deficiencies of causing irritation and discomfort to the user after prolonged use as not two persons are the same and the shape of the ear varies from person to person.

Another solution available in the market is the use of a chain or a chord. The chain or chord has one end attached to the earbud and another end equipped with a clip for clipping to the user's ear. The clip may be clipped to the helix, antihelix, scaphoid fossa, or lobule of the ear. The problem of this approach is also related to the discomfort caused and the potential harm to the ear if the earbud is caught up and pulled away from the user, in particular for the case when the chain or chord is hooked to an ear-piercing hole.

Some other wired solutions may include a wire connecting the two earbuds together in hope that when one of the earbuds is dislodged, the other earbud is still attached without falling off. The connecting wire may be placed around the back of the user's neck. The problem of this solution is that the other earbud may also fall if the pulling force on the first earbud or the connecting wire is too strong. The wearer also looses the benefit of a “Wireless Solution” with this method.

In view of the foregoing deficiencies, there is a need in the art for a device attached to an earbud that prevents the earbud from fall out to the ground. Furthermore, other desirable features and characteristics will become apparent from the subsequent detailed description and the appended claims, taken in conjunction with the accompanying drawings and this background of the disclosure.

### SUMMARY

The present invention discloses a balancing device for preventing accidental fall out of a wireless earbud or TWS (True wireless Stereo) earbuds, when the wireless earbud is dislodged. The balancing device includes a flexible element arranged to wrap around the back of the ear; and a counterweight, wherein the flexible element is configured to hang over the top of a user's ear and the counterweight is attached to the flexible element to counteract the weight of the wireless earbud, thereby the wireless earbud is stopped from slipping off and falling to the ground.

The balancing device is attachable to and detachable from the earbud. The balancing device comprises a first attachment mean, a flexible element, a second attachment mean, and a counterweight.

The first attachment mean is used for connecting the balancing device to the earbud. The first attachment mean may be a silicone sleeve, a plastic clip, or other aftermarket solution for connecting the balancing device to the earbud. Alternatively, the first attachment mean may be partially formed on the casing of the earbud. The casing of the earbud may include a hook, a loop, a magnetic element, or other means for reliably fixing the balancing device thereto.

In another embodiment, the elements involved in the balancing device may be interchangeable and decorative. The balancing device may be a jewellery element.

In another embodiment, the counterweight can be made of different weights to counter the weight of different type of earbuds in the market.

In another embodiment, the flexible element includes a high frictional surface so that the slipping movement of the flexible element along the eminence of concha is slowed down.

In another embodiment, the counterweight may be decorative ear jewellery or a hanging ear ring.

In another embodiment, the weight of the counterweight may be adjusted according to user's comfort or preference.

### BRIEF DESCRIPTION OF THE DRAWINGS

The appended drawings contain figures to further illustrate and clarify the above and other aspects, advantages, and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings.

The diagrams are for illustration only, which thus is not a limitation of the present disclosure, and wherein:

FIG. 1 illustrates an example of the balancing device attachable to the earbud for preventing accidental fall out of the earbud in accordance with certain embodiments of the present invention.

FIG. 2 illustrates a front and rear view of the balancing device with earbud worn by a user in accordance with the certain embodiments of the present invention.

FIG. 3 illustrates an example of the front view of the balancing device attachable to the earbud in accordance with certain embodiments of the present invention.

FIG. 4 illustrates a rear view of the balancing device with earbud as depicted in FIG. 1;

FIG. 5 illustrates the mechanism and front view of the balancing device when the earbud is dislodged.

FIG. 6 illustrates a rear view of the balancing mechanism, when the ear-bud is dislodged.

FIG. 7A illustrates a first configuration of the balancing device comprising a flexible element for attaching to an earbud.

FIG. 7B illustrates a second configuration of the balancing device connected to an earbud comprising a small physical hook.

FIG. 7C illustrates a third configuration of the balancing device connected to an earbud comprising a large physical hook.

FIG. 8A illustrates an attachment clip for connecting a small or large physical hook to the earbud casing.

FIG. 8B illustrates a counterweight attached to the large physical hook.

FIG. 9 is an exemplary implementation of the one of the configuration of the balancing device.

FIG. 10 is an exemplary implementation of one of the configuration with certain embodiment of the present invention.

FIG. 11A-11C illustrates various exemplary embodiments of counter-weights as ear jewellery in accordance with the certain embodiments of the present invention.

Skilled artisans will appreciate that elements in the figures are illustrated for simplicity and clarity and have not necessarily been depicted to scale.

### DETAILED DESCRIPTION OF THE DRAWINGS

The present disclosure generally relates to a device attached to an ear-fitting wireless earbud OR TWS for minimizing the chance of accidental falling to the ground of the ear-fitting wireless earbuds. More specifically, but without limitation, the present disclosure relates to a balancing device attached to an earbud for preventing accidental fall out of the earbud to the ground.

The following detailed description is merely exemplary in nature and is not intended to limit the disclosure or its application and/or uses. It should be appreciated that a vast number of variations exist. The detailed description will enable those of ordinary skilled in the art to implement an exemplary embodiment of the present disclosure without undue experimentation, and it is understood that various changes or modifications may be made in the function and structure described in the exemplary embodiment without departing from the scope of the present disclosure as set forth in the appended claims.

The benefits, advantages, solutions to problems, and any element(s) that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims as issued.

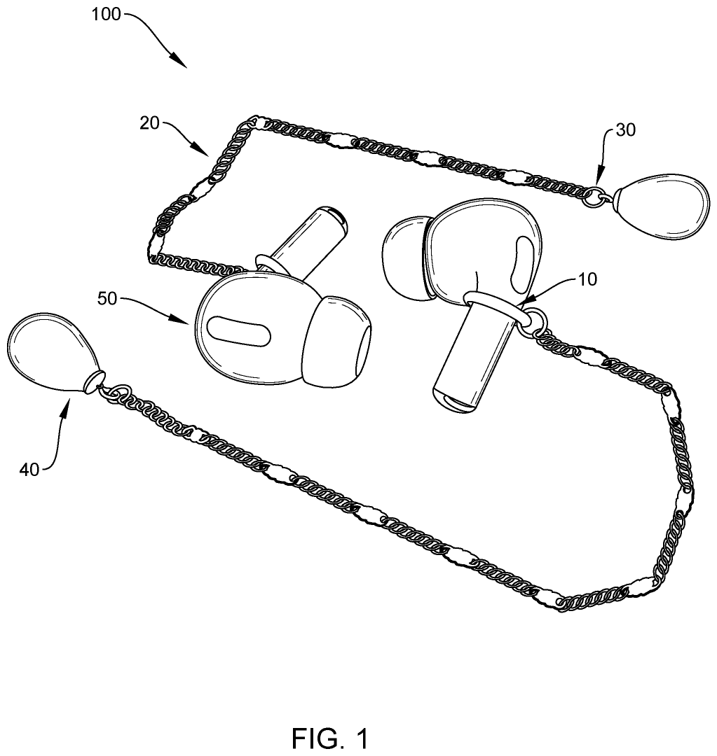

FIG. 1 illustrates an example of the balancing device attachable to the earbud in accordance with certain embodiments of the present invention. FIG. 1 clearly illustrates how the balancing device of the present invention prevents the accidental fall of the wireless earbud 50 or the TWS. The earbud(s) is/are communicatively connectable to the mobile device by Bluetooth® technology or other wireless communication protocol. The wireless earbud OR TWS uses winless technology but not limited to Bluetooth technology to digitally encode the audio and wirelessly transmit the signal over a short distance to and from the linked mobile device. a balancing device 100 is attachable to and detachable from the earbud 50. The balancing device 100 comprises a first attachment mean 10, a flexible element 20, a second attachment mean 30, and a counterweight 40.

The first attachment mean 10 is used for connecting the balancing device 100 to the earbud 50. The first attachment mean 10 may be a silicone sleeve, a plastic clip, or other aftermarket solution for connecting the balancing device 100 to the earbud 50. Alternatively, the first attachment mean 10 may be partially formed on the casing of the earbud 50. The casing of the earbud 50 may include a hook, a loop, a magnetic element, or other means for reliably fixing the balancing device 100 thereto.

Due to the visible nature of the present disclosure for the balancing device 100 with a counterweight 50, the elements involved in the balancing device 100 may be interchangeable and decorative. The first attachment mean 10 may not be a permanent fixture, and may be a hook, a loop, a magnetic housing or an interchangeable sleeve, to which the flexible element 20 may be attached thereto.

The flexible element 20 preferably be a chain, but may be a chord, a piece of wire, a cable, plastic, or other material that is flexible and conforms to the unique shape of the user's ear. The flexible element is used to connect the earbud 50 to the counterweight 40, and in the first configuration, the flexible element 20 is arranged to wrap around the back of the ear. In greater detail, the earbud 50 is secured within the opening of the auditory canal of the ear, and the flexible element 20 travels behind the helix of the user's ear and along the eminence of concha on the medial surface of the ear, thereby the counterweight 40 is hanged down from the ear.

The flexible element 20 is attached to the earbud 50 via the first attachment mean 10. Once attached, the flexible element 20 is placed across the helix of the ear to hang down from the back of the ear. Due to the flexible nature, the flexible element 20 conforms to the shape of the user's ear, which is more comfortable than a ridged clip or other solutions conventionally found in the market. In certain embodiments, the flexible element 20 includes a high frictional surface so that the slipping movement of the flexible element 20 along the eminence of concha is slowed down.

In particular, the flexible element 20 may be a polished chain commonly used in jewelry, or a rope chain, or other flexible material with an appealing or designed appearance. This can be interchangeable to offer the wearer different looks without the need to replace the entire earbud 50.

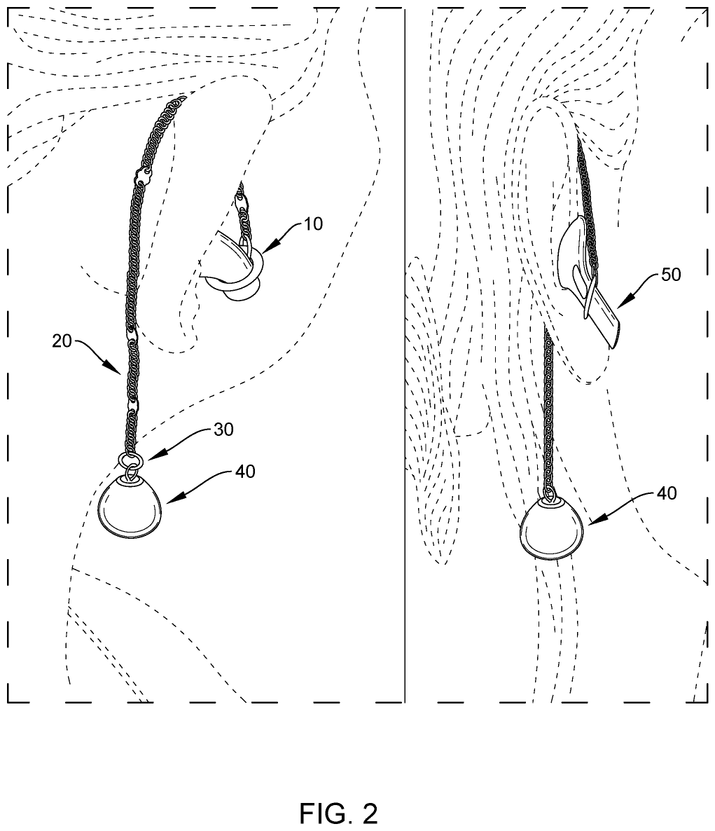

FIG. 2 illustrates a front and rear view of the balancing device with earbud worn by a user in accordance with the certain embodiments of the present invention. FIG. 2 clearly illustrates the way the balancing device of the present invention can be used with a wireless earbud or TWS. The front and rear view demonstrates how the flexible element fits on the outer canal of the ear. The first attachment means 10 connected to the earbud and second attachment means 30 connected to the counterweight.

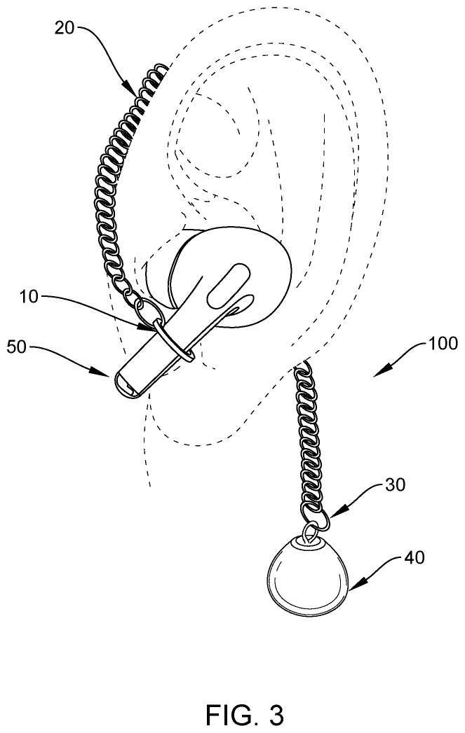

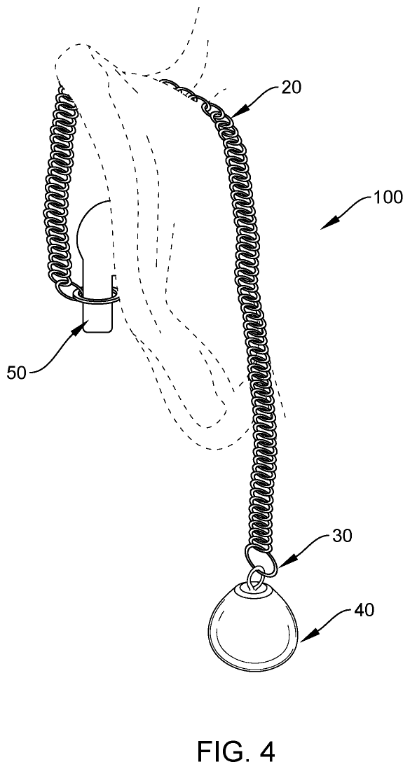

FIG. 3 is an example use of the balancing device attachable to the wireless earbud for preventing an accidental fall to the ground of the earbud in accordance with certain embodiments of the present invention. The earbud is worn by a user with the balancing device of the present invention. As seen in FIGS. 3 and 4, a balancing device 100 is attachable to and detachable from the earbud 50. The balancing device 100 comprises a first attachment mean 10, a flexible element 20, a second attachment mean 30, and a counterweight 40.

On the other end of the flexible element 20, there is provided a second attachment means 30 for connecting to the counterweight 40. The second attachment mean 30 may include a hook, a loop, a magnetic element, or other means for reliably fixing the counterweight 40 thereto.

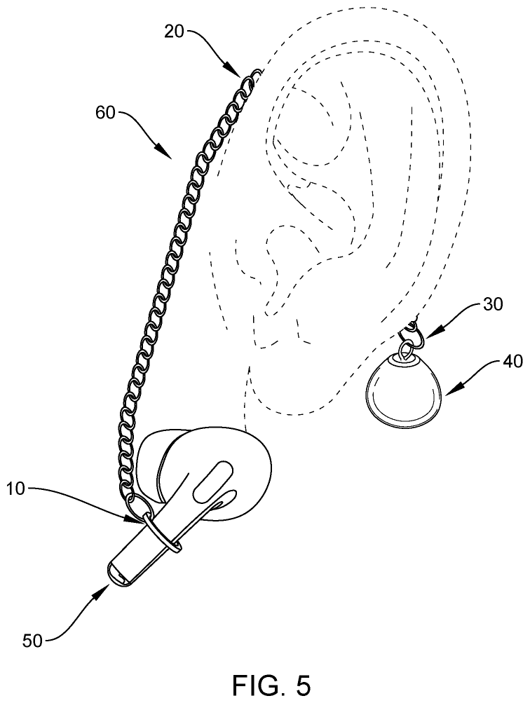

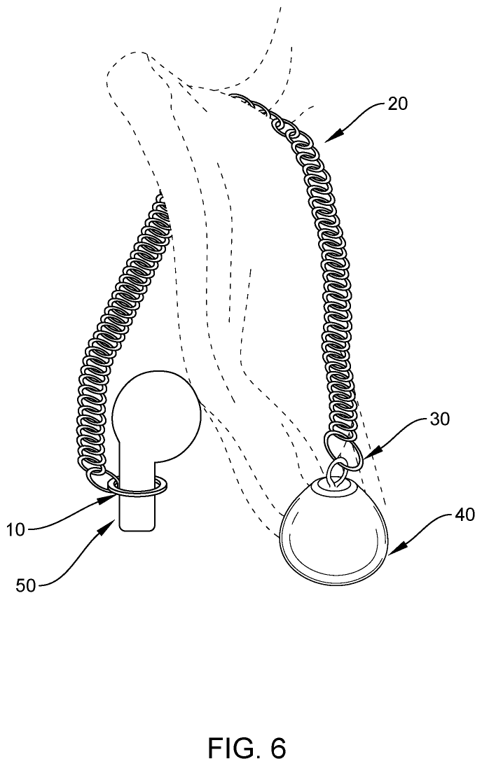

The counterweight 40 may have a weight similar to the earbud 50. However, it is apparent that the counterweight 40 may also have a weight different from the earbud 50, as long as the weight is sufficient to slow down the fall of the earbud 50 when the earbud 50 becomes dislodged. As shown in FIGS. 5 and 6, this mechanism allows the user to feel the movement of the earbud 50, and realize the slipping of the flexible element 20 along the eminence of concha, thereby the user has sufficient time to react to the slipping movement and can catch the earbud 50 before the earbud 50 falls to the ground.

The counterweight 40 may be permanently fixed to the flexible element 20, or the counterweight 40 may be interchangeable via the second attachment mean 30, which allows the counterweight and the second attachment mean 30 to have an appealing look and double as a decorative piece. In certain embodiments, the counterweight 40 may be a hanging ear ring.

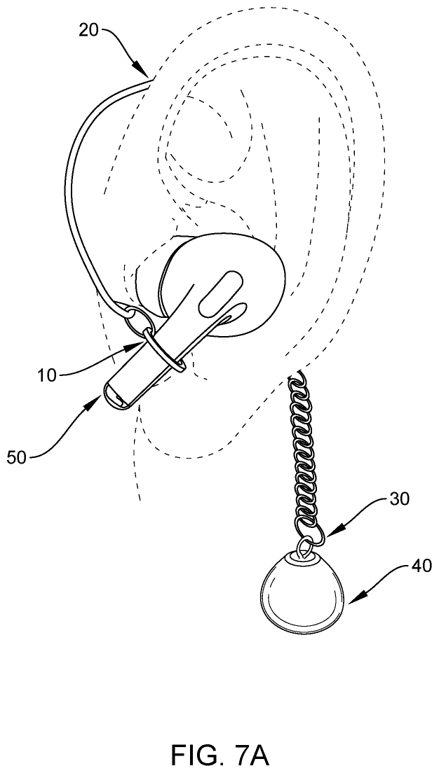

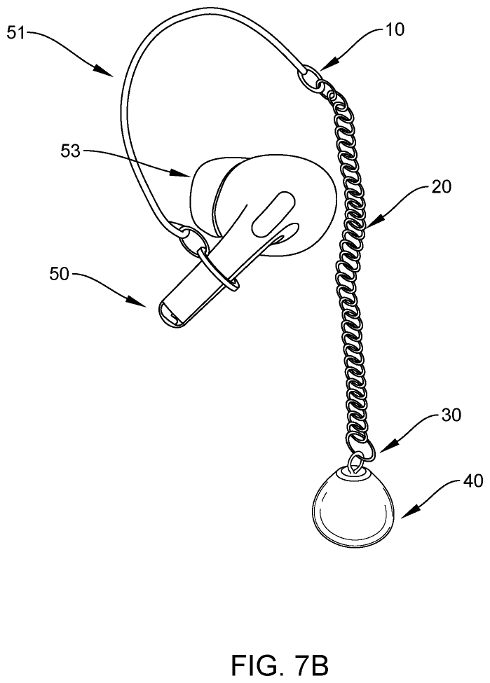

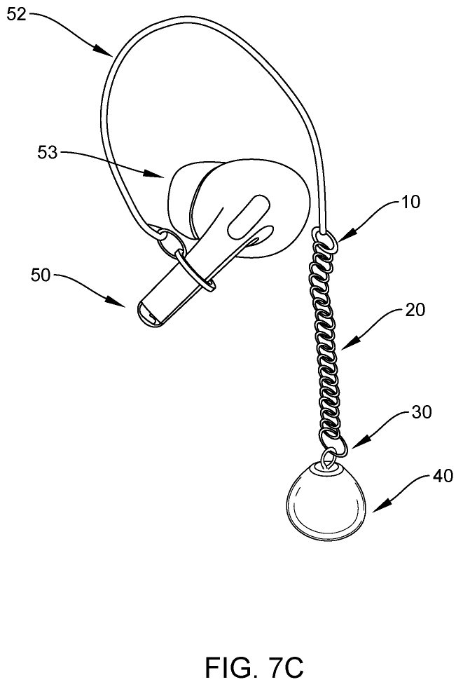

FIGS. 7A-7C shows three configurations of the balancing device 100 in accordance with the present invention. FIG. 7A provides a configuration of the balancing device 100 having a chain as the flexible element 20 connected to the earbud 50. FIG. 7B provides a configuration of the balancing device 100 connected to an earbud 50 comprising a small physical hook 51. FIG. 7C provides a configuration of the balancing device 100 connected to an earbud 50 comprising a large physical hook 52. With the small physical hook 51 or the large physical hook 52, sliding will not happen and the weight of the counterweight 30 will help to keep the earbud 50 securely clipped on the ear.

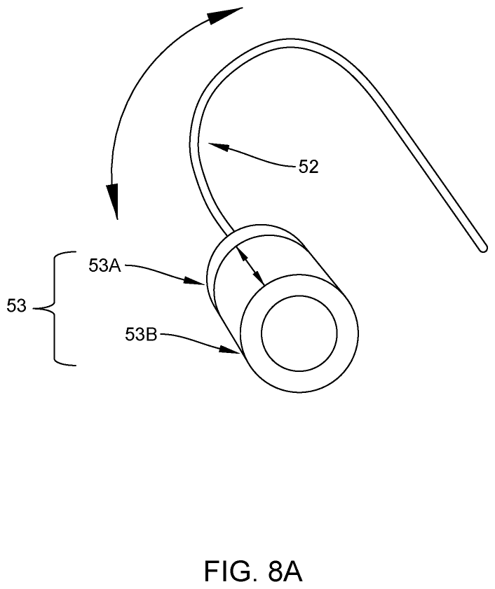

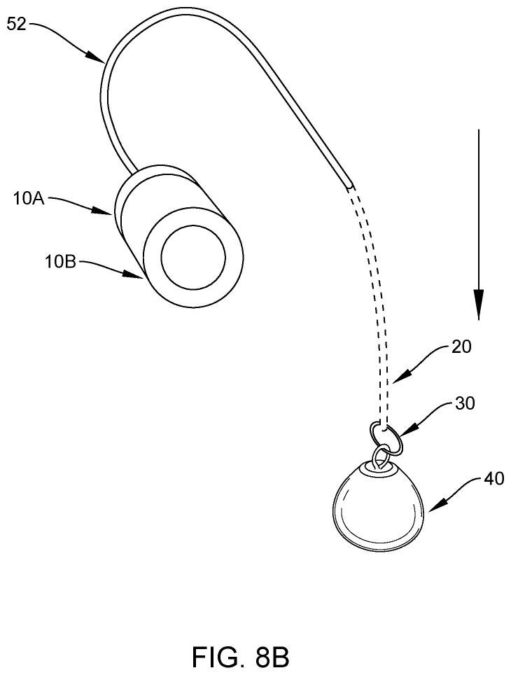

As shown in FIG. 8A, the earbud 50 is connected to the small physical hook 51 or the large physical hook 52 via a connector 53 to firmly attached thereto, wherein the connector 53 includes a plastic hook 53B on the physical hook side and an attachment clip 53A on the earbud casing side. The attachment clip 53A is configured to clip onto the casing of the earbud 50, but the hook 53B allows the attachment clip 53A to rotate freely. The risk, therefore, exists that the hook could slip out of location and not stops the earbud 50 from falling to the ground as it is not correctly positioned over the top of the ear.

Now refer to FIG. 8B, the earbud 50 is connected to a counterweight 40 for balancing the weight of the earbud 50 and keeping the small physical hook 52 or the large physical hook 52 in place through the additional weight and the resulting downward force over the top of the ear. Thus movement or rotation of the ridged clip or in the case of the clip being permanently fixed to the earbud and the clip not rotating, the rotation of the entire earpiece is reduced. Any movement out of such a location would also be felt more by the wearer as a change in the position of the counter weight would be noticeable by the wearer (a weight swinging freely under a person's ear is noticeable) and they could make an adjustment accordingly to prevent the earbud 50 accidentally falling to the ground.

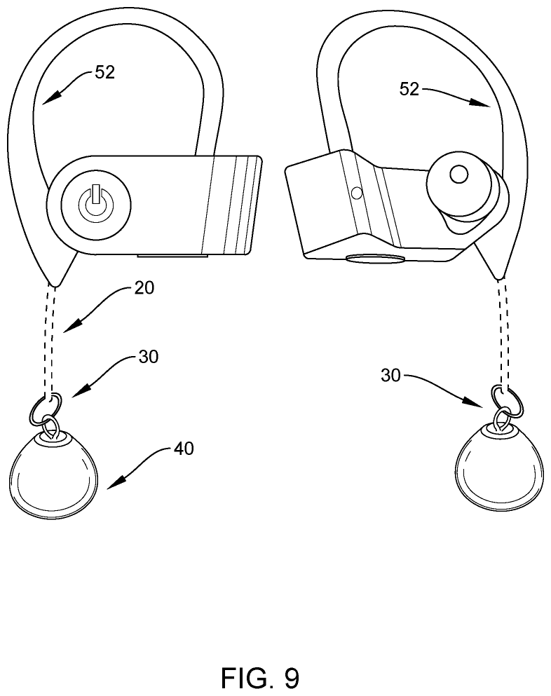

FIG. 9 shows an exemplary implementation of the third configuration of the earbud 50 having a small physical hook 52 or the large physical hook 52. The physical hook may or may not be a permanently fixed to the earpiece. With the counterweight 40, the risk of losing the physical hook from the back of the ear is reduced, and the additional weight can help to maintain the earbud 50 in the intended location.

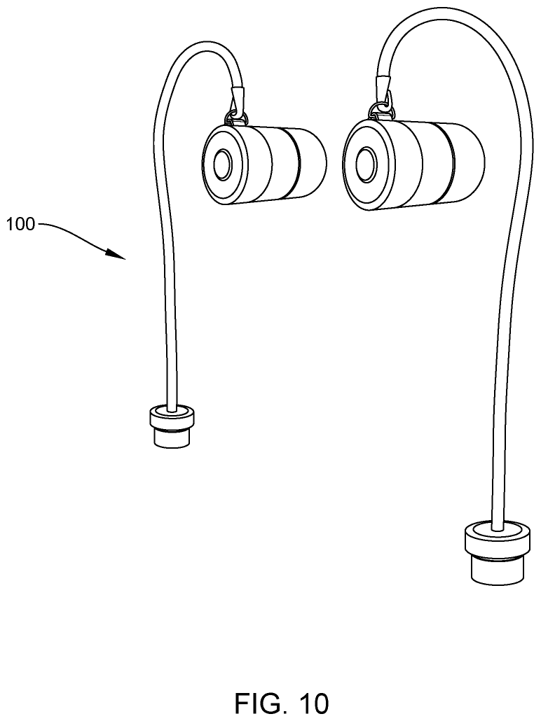

FIG. 10 shows an exemplary implementation of the first configuration of the balancing device 100. The earbud may also be decorated in such a way similar to and matched with the counterweight.

As seen in FIG. 10, the second attachment mean may be configured to hold the counterweight from the top side of the counterweight, but it is apparent that the second attachment mean may also be configured to hold the counterweight from the bottom as long as the counterweight is not allowed to slip off the flexible element. Whatever the configuration, both approaches are aimed to attach the counterweight to the flexible element to provide a balancing of the earbud.

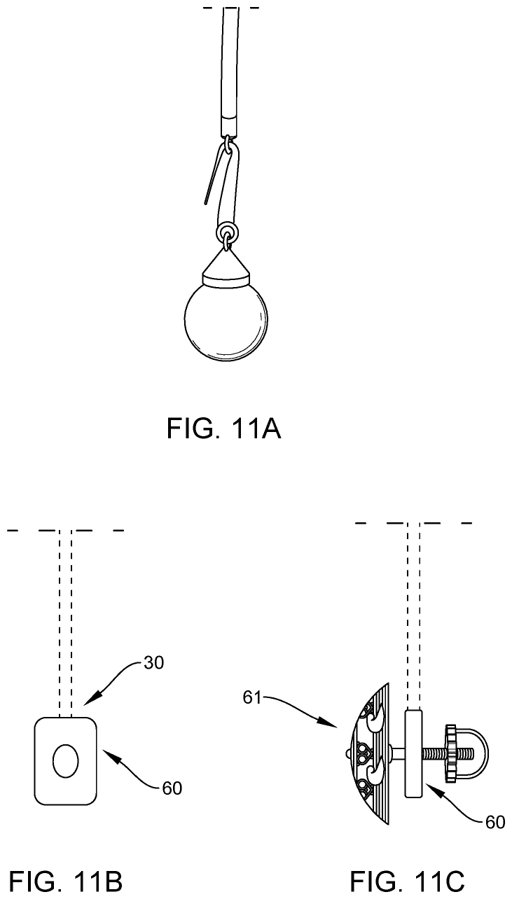

FIG. 11A-11C illustrates various exemplary embodiments of counter-weight in accordance with the certain embodiments of the present invention. The counter-weight can be decorative or part of ear-jewellery of different shapes and sizes. These counter weights are replaceable or interchangeable. FIG. 11A-11C also illustrates that the current invention can be used with current or regular ear-ring. A regular ear-ring can also act as a counterweight. FIG. 11A is also an example of illustrating an ear-ring as counterweight. A small metal plate with hole as illustrated in FIG. 11B can be attached as illustrated in FIG. 11C with regular ear-ring.

This illustrates the fundamental structure and mechanism of the balancing device in accordance with the present disclosure. The balancing device is attached to an earbud for preventing accidental fall out of the earbud to the ground when the earbud is dislodged. It is apparent that the present disclosure may be embodied in other applications, such as hearing aids, without departing from the spirit or essential characteristics thereof. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. A balancing device (100) for stopping a wireless earbud (50) from falling to the ground when the wireless earbud is dislodged, the balancing device (100) comprising:
a first attachment means (10), for connecting the earbuds (50) to the balancing device (100);
a flexible element (20) arranged to wrap around the back of the ear;
a second attachment means (30) for connecting the flexible element (20) with a counterweight (40);
wherein a counterweight (40), connected to the second attachment means (20) is configured to hang over the top of a user's ear and the counterweight through the flexible element to counteract the weight of the wireless earbud (50), thereby stops the wireless earbud from slipping off and falling to the ground.

2. The balancing device of claim 1, wherein a combination of the flexible element and the counterweight provides a frictional force across the back of the ear to stop the wireless earbud from slipping off and falling to the ground.

3. The balancing device of claim 1, wherein the flexible element may attach to the wireless earbud permanently.

4. The balancing device of claim 1, wherein the flexible element may attach to the wireless earbud via an interchangeable attachment method.

5. The balancing device of claim 1, wherein the counterweight may attach to the flexible element permanently.

6. The balancing device of claim 1, wherein the counterweight may attach to the flexible element via an interchangeable attachment method.

7. The balancing device of claim 1, wherein the flexible element is a chain, a chord, a piece of wire, a cable, plastic, or other material.

8. The balancing device of claim 1, wherein the wireless earbud comprises a small physical hook or a large physical hook, and the flexible element is connected to the small physical hook or the large physical hook via a first attachment mean.

9. The balancing device of claim 1, where the weight of the counterweight may be different for different earbuds.

10. The balancing device of claim 1, wherein the weight of the counterweight may be adjusted according to user's comfort or preference.

11. The balancing device of claim 1, wherein the balancing device can be attached to a regular ear piece using a metal plate with hole.

12. The balancing device of claim 11, wherein the metal plate can be made from flexible metal such as gold, silver, iron or silicon or rubber like material.

13. A method for preventing a wireless earbud (50) from slipping from a user's ear via a flexible element (20) and a counterweight (40), wherein the counterweight has a size to lodge between the back of the ear, and a flexible element;
the counterweight (40) provides a frictional force preventing the earbud from falling to the ground.

14. A method of claim 13, wherein the method for preventing a wireless earbud from slipping from a user's ear via a flexible element, secondary element and a counterweight, wherein the combination of the flexible element, secondary element and the counterweight provides a frictional force to slow the fall of the earbud to the ground.

15. A method of claim 12, wherein the method for preventing a wireless earbud from slipping from a user's ear via a small or a large hook, a flexible element and a counterweight, wherein the combination of the flexible element and the counterweight attached to the hook prevents the rotation of the hook out of place behind the users ear, keeping the earbud on the ear and preventing an accidental fall of the earbud to the ground.
